(19) United States
(12) Patent Application Publication
(10) Pub. No.: US 2022/0227557 A1
(43) Pub. Date: Jul. 21, 2022

(54) MULTI-LAYER COVERS WITH DETACHABLE SEGMENT AND METHOD OF THEIR PRODUCTION

(71) Applicant: K.GKIKAS & CO LP, Pefki (GR)

(72) Inventors: Anastasia GKIKA, Pefki (GR); Konstantinos GKIKAS, Pefki (GR)

(21) Appl. No.: 17/609,440

(22) PCT Filed: Apr. 7, 2020
(86) PCT No.: PCT/IB2020/053293

§ 371 Date: Nov. 8, 2021

(30) Foreign Application Priority Data
May 9, 2019 (GR) 20190100201
May 9, 2019 (GR) 20190100202

(51) Int. Cl. B65D 75/58; B32B 37/12; B32B 37/26

(52) U.S. Cl. CPC B65D 75/5855; B65D 75/5894; B65D 75/5838; B32B 2439/40; B32B 37/26; B65D 2575/586; B32B 2037/268; B32B 37/12

(57) ABSTRACT

The invention refers to closures or covers 20 of containers for facial tissues, wipes and in particular wet wipes, diapers and in general items that require to remain within a container 50, with no direct contact with the environment. The cover 20 includes an inner layer 22 and an outer layer 24, both having an inner face and an outer face, whereby the inner faces of the both layers 22, 24 comprise means to adhere to each other. The outer face of the inner layer 22 is at least partially coated with reclosable adhesive to adhere, to a container 50. The inner layer 22 has a detachable segment 35b, which adheres to the outer layer 24 and which has an outer face that is part of the outer face of the inner layer 22 and that it is at least partially covered with reclosable adhesive. The inner layer 22 and/or the outer layer 24 comprises means 34, 36 to allow separation and subsequent withdrawal of the detachable segment 35b from the cover 20. Further, the invention suggests a method for producing a roll with covers 20.

The invention refers to closures and covers. In particular the invention refers to closures or covers of containers for facial tissues, wipes and in particular wet wipes, diapers and in general items that require to remain within a container and with no direct contact with the environment.

Closures or covers of containers are usually fabricated from a layer of self-adhesive material that adheres to the surface of the lid of the container. Such containers have an opening and a lid to cover the opening and to protect the interior of the container from the environment. In order to provide an adequate closure of the opening of the container, it is known to use a cover that adheres to the lid and to the area of the surface of the container that is around the lid. By doing so, the lid is protected and remains in its place. Known covers have a main section and a base section. The base section is attached to the box when the cover is in a closed position or lifted to allow access to the interior of the container. However, after the user lifts and attaches the main section of the cover to the surface of the container a few times, dirt damages the adhesive and subsequently the cover cannot adhere properly to the surface of the container around the lid. It is noted that as the main section of the cover adheres to the lid, the lid opens the opening of the container when the main section is lifted and closes the opening of the container when the main section adheres to the surface of the container.

The invention aims in a closure or a cover of a container and a container that overcomes the problems of the known containers. A further object of the invention is a closure that seals a container so that the content of the container is protected from the environmental conditions. A further object of the invention is a method to produce covers that may be lifted and adhere to a container that contains wet wipes and other similar items, as many times as needed, with no problems. A further object of the invention is an eco-friendly packaging for facial tissues, wipes and in particular wet wipes, diapers and other similar consumable products.

The invention is defined in the independent claims.

A cover according to the invention performs without problem during its life-time, is light and uses a relatively small amount of preferably recyclable material. The method of its production is efficient and it may be easily applied to cover openings of containers or other items.

Dependent claims contain features that offer further advantages.

A cover according to the invention includes an inner layer that has an inner face and an outer face and an outer layer that has an inner face and an outer face, whereby the inner face of the outer layer and the inner face of the inner layer comprise means to adhere the inner layer and the outer layer to each other, the outer face of the inner layer is at least partially coated with reclosable adhesive to adhere, in use, at least partially to a surface, the inner layer has a detachable segment, which adheres to the outer layer and which has an outer face that is part of the outer face of the inner layer and that it is at least partially or totally covered with reclosable adhesive and at least one of the inner layer and the outer layer comprises means to allow separation and subsequent withdrawal of the detachable segment from the cover.

The detachable segment may be ring shaped and surround the fixed segment. A ring shaped detachable segment may have any form, for example its inner periphery may have an oval shape. In another embodiment the detachable segment is C-shaped. Preferably, the detachable segment surrounds at least partially a fixed segment of the inner layer. Between the detachable segment and the fixed segment there is a cut that facilitates the separation of the detachable segment and the fixed segment and subsequent withdrawal of the detachable segment from the cover. The detachable segment has an inner face that is part of the inner face of the inner layer and that is coated at least partially or totally with release varnish. The inner face of the detachable segment adheres to an area of the inner face of the outer layer, which area is at least partially coated with reclosable adhesive.

The means facilitating separation and subsequent withdrawal of the detachable segment from the cover may be one or more cuts and/or one or more perforation lines provided on the inner layer. A cut may be achieved by engraving a layer.

In an embodiment of the invention, the cover has a base section including a portion of the inner layer and a portion of the outer layer, with a cut or a perforation line, preferably a cut, between the detachable segment and the inner layer of the base section. Optionally, the cover has a flap including a portion of the inner layer and a portion of the outer layer, with a perforation line between the detachable segment and the portion of the inner layer of the flap.

The cover may be applied on the external surface of a container with means to allow access in the interior of the container, preferably an opening. The detachable segment of the inner layer adheres at least partially to the external surface of the container with reclosable adhesive. Optionally, the container has a lid that covers the opening. The detachable segment adheres to the external surface of the container around the opening and optionally around the lid. When the container has a lid, the fixed segment of the inner layer of the cover adheres permanently to the lid. The base section is fixed to the container and the flap facilitates the user to lift the cover from the container.

The invention suggests a method of production of a roll with a plurality of covers, whereby each cover includes an outer layer, an inner layer with a detachable segment and means facilitating the withdrawal and removal of the detachable segment from the inner layer, the method comprising the following steps: (i) providing a roll with a liner and a self-adhesive layer with a first face that adheres with reclosable adhesive to the liner and a free face; (ii) applying a release varnish on predefined areas of the free face, whereby the predetermined areas correspond to the detachable segments of the covers under production; (iii) engraving or perforating the self-adhesive material of the roll to form a border of the detachable segment of the covers under production and producing the means other than said border facilitating the separation and removal of the detachable segments from the inner layer of the covers under production; (iv) adhering a further self-adhesive layer to the free face of the self-adhesive layer of the roll; (v) engraving the sandwich of the self-adhesive layer of the roll and the further self-adhesive layer, so as to produce a plurality of covers and waste material.

Preferably, the predefined areas on which the release varnish is applied, enclose at least partially areas of the outer face of the inner layer, on which no release varnish is applied, so as to be fixed to the further self-adhesive layer.

In preferred embodiments, the method comprises engraving the self-adhesive material of the roll to form a border between the detachable segment and a fixed segment of the inner layer of the covers under production and perforating the self-adhesive material of the roll to form a border between the detachable segment and a flap of the covers under production. The fixed segment and the flap of each cover are distinct elements with at least part of the detachable segment being in between.

Optionally, the liner is separated from the self-adhesive layer, the adhesive is cancelled or removed on areas of the first face of the self-adhesive layer, which correspond to flaps of the covers under production, and subsequently the liner and the self-adhesive layer are recombined. The separation of the liner from the self-adhesive material may be performed before, after or during application of the release varnish.

The covers have at least two layers. Some embodiments of the invention may include more than two layers, for example three or four.

Embodiments of the invention will be described with reference to the following Figures:

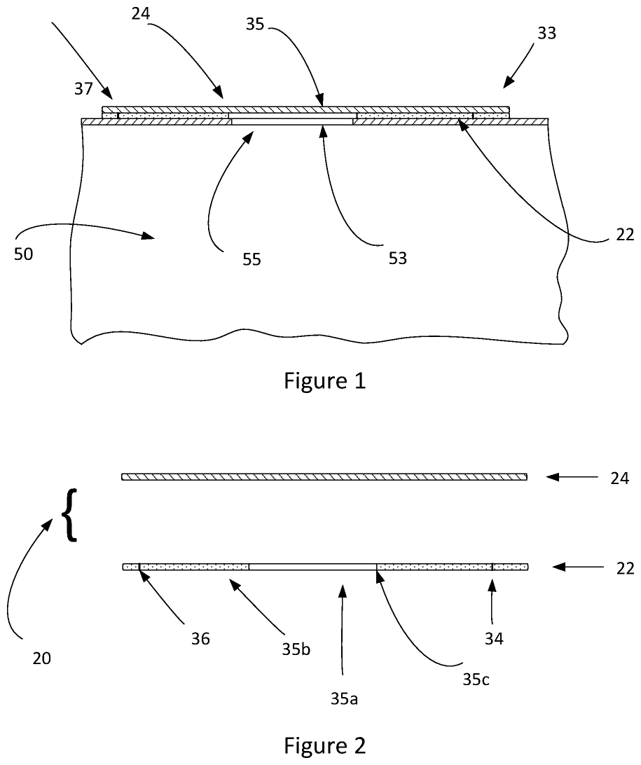

FIG. 1 presents a section of a cover on a container

FIG. 2 presents the layers of the cover of FIG. 1 separated

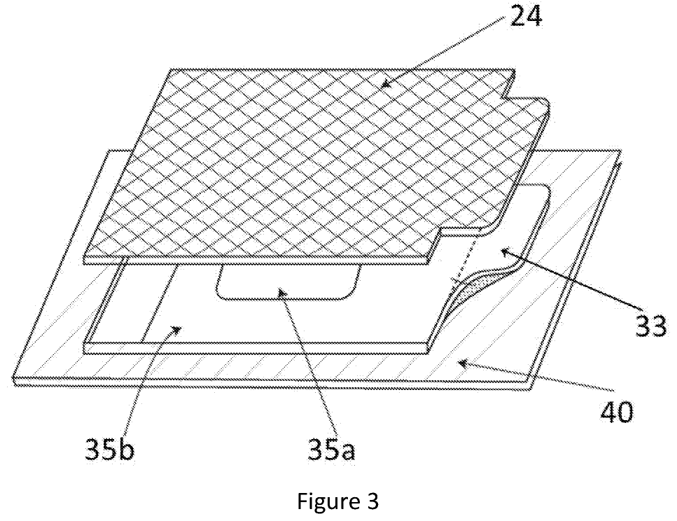

FIG. 3 presents a 3-D view of the container with the cover of FIG. 1

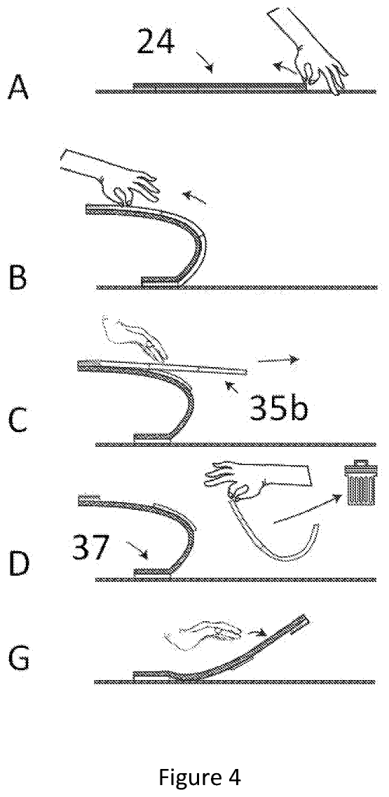

FIG. 4 presents the removal and withdrawal of the detachable segment of the cover

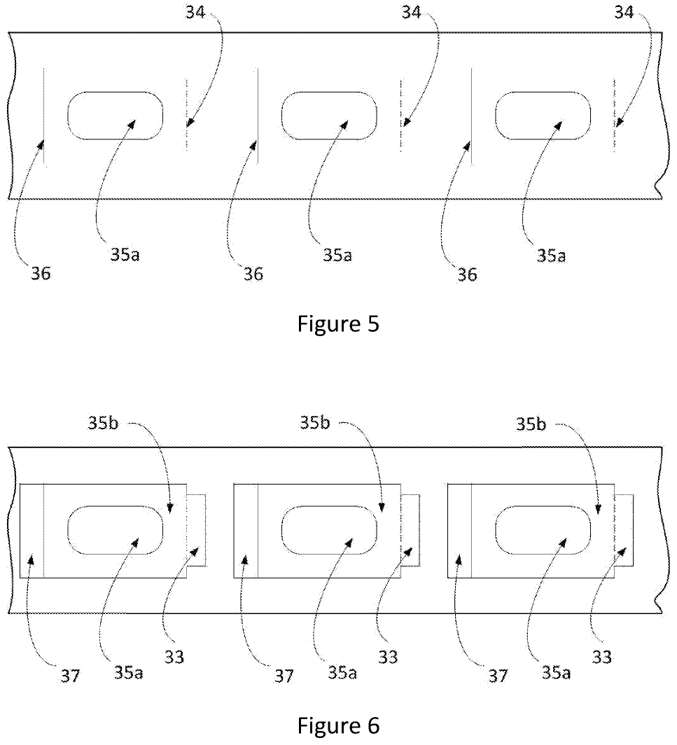

FIG. 5 presents an intermediate stage of production of a cover according to the invention

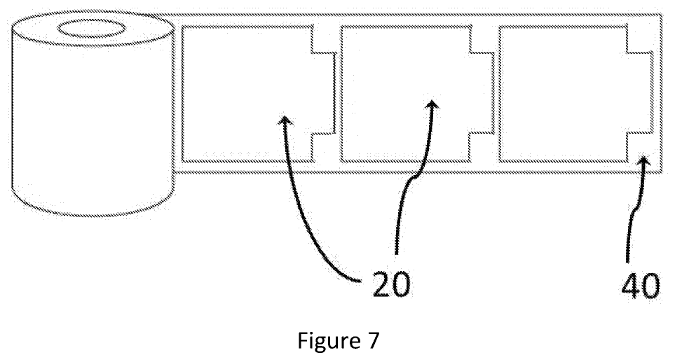

FIG. 6 presents a roll with covers towards the end of the production phase

FIG. 7 presents a roll with covers according to the invention

FIG. 1 shows a container 50 with an opening 55 and a lid 53 to cover the opening and to protect the interior of the container from the environment. A cover 20 covers the opening 55 and the lid 53 and protects the content of the container 50.

The cover 20 has two layers, an inner layer 22 and an outer layer 24, which adhere to each other. Each one of the inner layer 22 and the outer layer 24 has an inner face and an outer face. The inner face of the inner layer 22 and the inner face of the outer layer 24 adhere to each other. The outer face of the inner layer 22 adheres to the lid 53 of the container 50.

The cover 20 has a main section 35, a base section 37 and a flap 33. The base section 37 is attached to the container 50, either when the cover 20 is either in a closed position and prohibits access in the interior of the container 50 or lifted to allow access to the interior of the container 50. In use, the flap 33 is to be held by the user, i.e. when (s)he lifts the flap 33 or places the cover 20 in the closed position. The plan view of the base section 35 may be almost orthogonal or orthogonal as it is depicted in FIG. 6 or it may have other shapes, as for example it may have other shapes such as C, trough cross-section etc.

The layered structure of the cover 20 results that each section of the cover 20 has also two layers, i.e. an outer layer and an inner layer. Thus, the outer layer of main section 35, the outer layer of the base section 37 and the outer layer of the flap 33 are portions of the outer layer 24 of the cover 20 and the inner layer of the main section 35, the inner layer of the base section 37 and the inner layer of the flap 33 are portions of the inner layer 22 of the cover 20.

The outer face of the inner layer 22, i.e. the layer that is on the other side of the face that adheres to the outer layer 24, has adhesive to attach the cover 20 to the lid 53 of the container 50. When the lid 53 is in the closed position, the cover 20 adheres to the lid 53 as well as to the area of the container 50 that is around the lid 53. In order to facilitate the user to lift the cover 20 from the container 50, the outer face of the inner layer 22 of the flap 33 is free from adhesive. For example, this may be achieved during production by cancelling or removing the adhesive from the outer face of the inner layer 22 of the flap 33.

The border 34 between the inner layer 22 of the main section 35 and the inner layer 22 of the flap 33 is preferably perforated to facilitate separation of the main section 35 and the flap 33. Similarly the border 36 the between the inner layer 22 of the main section 35 and the inner layer 22 of the base section 37 is preferably engraved to facilitate separation of the main section 35 and the base section 37. Other means to facilitate separation, for example perforations instead of cuts, may be used. The perforation lines 34 and the cuts 36 of a series of covers 20 are depicted in FIG. 5, which shows schematically an intermediate stage of the production of a roll including covers 20. FIG. 6 shows schematically the roll towards the end of the production, with the contour of individual covers shown in full lines.

During production, the inner layer 22 of the main section 35 is cut in two segments, a fixed segment 35a and a detachable segment 35b. As shown in FIG. 1 and FIG. 2, the inner layer 22 of the main section 35 is split by a cut 35c to an elongated fixed segment 35a and a ring-shaped, detachable segment 35b that surrounds the fixed segment 35a. In another embodiment, the detachable segment may be C-shaped and surround partially the fixed segment. The fixed segment 35a is dimensioned so that it fits to the lid 53 of the container 50.

The inner face of the detachable segment 35b that adheres to the inner face of the outer layer 24 is partially coated with release varnish. The inner face of the outer layer 24 that adheres to the inner face of the detachable segment 35b has a layer of reclosable adhesive, i.e. an adhesive that may be used a plurality of times. Such adhesives are usually used, when an item is to be adhered or stuck and removed from a surface more than once. Items that are joined with a reclosable adhesive may be separated without being damaged.

In order to prohibit the detachment of the fixed segment 35a from the outer layer 24, the inner face of the fixed segment 35a that adheres to the inner face of the outer layer 24 is not coated with relish varnish. The shape, the dimensions and the means to impede the detachment of the fixed segment 35a from the outer layer 24 are only presented as one of many examples. In general these features are selected taking into consideration the features of the lid 53 of the container 50.

The inner and the outer layers of each one of the base section 37 and the flap 33 adhere to each other with adhesive that is preferably provided on the inner surface of the outer layer 24.

An example of a cover 20 has an inner layer 22 with a thickness within a range of 40 μm to 50 μm and an outer layer 24 within a range of 60 μm to 90 μm. In such an example the thickness of the cover 20 is less than 140 μm, so that the cover 20 may be soft and flexible. Preferably the inner layer 22 and the outer layer 24 are made of recyclable material, for example from polypropylene, i.e. PP.

The raw materials that are used for the production of a roll with adhesive covers include two rolls with a liner and a self-adhesive material. One of the rolls provides the inner layers of the covers and the other roll provides the outer layers of the covers. FIG. 5 shows the roll of raw material, which provides the inner layer of the covers, at an intermediate stage of production.

A method of production of a roll with the adhesive covers that are presented above includes the following steps:
Provide a first roll—raw material—with a liner 40 and a self-adhesive layer, i.e. face material, whereby the self-adhesive layer has a face in contact with the liner 40 and a free face. The face of the self-adhesive that is in contact with the liner 40 is coated with reclosable adhesive. In general, the use of reclosable adhesive allows the use of the adhesive a number of times, i.e. it allows to stick a surface that is provided with reclosable adhesive a plurality of times, without destroying it. The self-adhesive layer of the first roll will provide the inner layers 22 of the covers 20.
Separate the liner 40 and the face material of the first roll.
Cancel/remove the adhesive on the areas of the self-adhesive layer, which correspond to the flap 33 of the covers 20 that are under production.
Recombine the liner 40 with the face material.
Engrave the self-adhesive layer to form the cut 35c, which is a border line between the detachable segment 35b and the fixed segment 35a of each one of the covers 20 that are under production.
Perforate the self-adhesive layer to form the perforation line 34 between the detachable segment 35b and the flap 33 of each one of the covers 20 that are under production.
Engrave the self-adhesive layer to form the border 36 of the detachable segment 35b and the base section 37 of each one of the covers 20 that are under production. All three above mentioned engraving and perforation steps, which produce cuts 35c and 36 and perforation line 34, or any two of these steps may be performed simultaneously. Alternatively they may be performed sequentially.
Coat the outer face of the self-adhesive, i.e. the face that is not in contact with the liner 40, of the first roll with a release varnish. The coating is applied on the area of the outer face the liner 40, which corresponds to the detachable segments 35b of the covers 20 under production. In use, the detachable segments 35b will adhere to the surface of the container 50 around the lid 53 of the container 50. FIG. 5 presents the first roll, upon completion of the above mentioned steps.
Provide a second roll—raw material—with a liner and a self-adhesive layer, i.e. face material, whereby the self-adhesive layer has a face in contact with the liner. The face of the self-adhesive that is in contact with the liner, i.e. the inner face, is coated with reclosable adhesive. The self-adhesive layer of the second roll will provide the outer layers 24 of the covers 20.
Separate the liner and the face material of the second roll.
Attach the self-adhesive layer of the second roll on the self-adhesive layer of the first roll. The attachment is achieved by adhering the self-adhesive layer of the second roll to the self-adhesive layer of the first roll, which is partially coated with release varnish.
Cut the sandwich of the self-adhesive layer of the first roll and the self-adhesive layer of the second roll to produce the self-adhesive covers 20.
Remove the waste material that is produced during the cutting of the covers 20 to obtain a liner 40 that carries a plurality of self-adhesive covers 20. Such a roll is shown schematically in FIG. 7 and an individual cover 20 on the liner 40 is shown schematically in FIG. 3. In FIG. 3 the outer layer 24 is placed at a distance from the inner layer 22 in order to show the arrangement of the inner layer 22.

The width of the rolls that are used for the production, i.e. the raw material, may accommodate one, two or more series of covers 20. A solely indicative and preferable thickness of the self-adhesive layer of the first roll, i.e. the roll that provides the inner layer of the covers 20 is approximately 50 μm.

During production of the container 50, the covers 20 are removed from the liner and placed on the top of the lid 53 of the container 50, so that the fixed segment 35a covers the lid 53 and the detachable segment 35b adheres to the surface of the container 50 around the lid 53. When the user wishes to remove an item from the container 50 s(he) lifts the cover 20 that carries the lid 53, so as to provide access to the interior of the container 50 through its opening 55. After lifting and re-sticking the cover 20 to the container 50 a number of times, the reclosable adhesive on the outer face of the detachable segment 35b becomes ineffective, because of dirt etc. Then the user lifts the cover 20 and removes the detachable segment 35b, while the inner layer of the flap 33 and the inner layer of the base section 37 are separated from the main section 35. The separation is facilitated by the perforation 34 and the cuts 36. The fixed segment 35a remains adhered to the outer layer, with the lid 53 attached to it. Separation of the fixed segment 35a form the detachable segment 35b is facilitated by the cut 35c.

FIG. 4 illustrates the sequence of the withdrawal and removal of the detachable segment 35b from the cover 20: A designates the lifting of the cover 20 from a surface, B, C and D designate the removal of the detachable segment 35b and G designates the attachment of the cover 20 on the surface after the removal of the detachable segment 35b. After the removal of the detachable segment 35b, the cover 20 may still cover and seal the opening of the container 50, with the inner surface of the outer layer of the main section 35 adhering with reclosable adhesive thereto.

An embodiment of the cover 20 according to the invention includes an inner layer 22 that has an inner face and an outer face and an outer layer 24 that has an inner face and an outer face, whereby the cover has a main section 35 that includes a portion of the inner layer 22 and a portion of the outer layer 24, a base section 37 that includes a portion of the inner layer 22 and a portion of the outer layer 24 and a flap 33 that includes a portion of the inner layer 22 and a portion of the outer layer 24, the main section 35, the base section 37 and the flap 33 being three distinct sections. The inner face of the outer layer 24 and the inner face of the inner layer 22 comprise means to adhere the inner layer 22 and the outer layer 24 to each other, the outer face of the inner layer 22 is at least partially coated with reclosable adhesive to adhere, in use, at least partially to a surface. The portion of the inner layer 22 that is included in the main section 35 has a fixed segment 35a and a detachable segment 35b, which detachable segment 35b adheres to the outer layer 24 and has an outer face that is part of the outer face of the inner layer 22 and is at least partially covered with reclosable adhesive, and between the detachable segment 35b and the fixed segment 35a there is a border 35c that facilitates separation of the detachable segment 35b and the fixed segment 35a. Further, at least one of the inner layer 22 and the outer layer 24 comprises means other than said border 35c to allow separation and subsequent withdrawal of the detachable segment 35b from the cover 20.

1. Cover (20) including an inner layer (22) that has an inner face and an outer face and an outer layer (24) that has an inner face and an outer face, whereby
the inner face of the outer layer (24) and the inner face of the inner layer (22) comprise means to adhere the inner layer (22) and the outer layer (24) to each other,
the inner layer (22) has a detachable segment (35b) which adheres to the outer layer (24) and which has an outer face that is part of the outer face of the inner layer (22) and that is at least partially covered with reclosable adhesive,
the detachable segment (35b) has an inner face that is part of the inner face of the inner layer (22) and the inner face of the detachable segment (35b) adheres to an area of the inner face of the outer layer (24), which area is at least partially coated with reclosable adhesive
at least one of the inner layer (22) and the outer layer (24) comprises means (34, 35c, 36) to facilitate separation and subsequent withdrawal of the detachable segment (35b) from the cover (20).

2. Cover according to claim 1, whereby the detachable segment (35b) has an inner face that is part of the inner face of the inner layer (22) and the inner face of the detachable segment (35b) is coated at least partially with release varnish.

3. Cover according to claim 1, whereby the means to facilitate separation and the subsequent withdrawal of the detachable segment (35b) from the cover (20) comprises one or more cuts (36) and/or one or more perforation lines (34) provided on the inner layer (22).

4. Cover according claim 1, which has a flap including a portion of the inner layer (22) and a portion of the outer layer (24), with a perforation line (34) between the detachable segment (35b) and the portion of the inner layer (22) of the flap (33).

5. Cover according to claim 1, whereby the inner layer (22) has a fixed segment (35a), the detachable segment (35b) surrounds at least partially the fixed segment (35a) and between the detachable segment (35b) and the fixed segment (35a) there is a cut (35c) that facilitates the separation of the detachable segment (35b) and the fixed segment (35a).

6. Cover according to claim 1, whereby the inner layer (22) has a fixed segment (35a), the detachable segment (35b) forms a ring around the fixed segment (35a) and between the detachable segment (35b) and the fixed segment (35a) there is a cut (35c) that facilitates the separation of the detachable segment (35b) and the fixed segment (35a).

7. Cover according to claim 1, whereby
the cover has a main section (35) that includes a portion of the inner layer (22) and a portion of the outer layer (24), a base section (37) that includes a portion of the inner layer (22) and a portion of the outer layer (24) and a flap (33) that includes a portion of the inner layer (22) and a portion of the outer layer (24), the main section (35), the base section (37) and the flap (33) being three distinct sections,
the portion of the inner layer (22) that is included in the main section (35) comprises the detachable segment (35b) and a fixed segment (35a),
between the detachable segment (35b) and the fixed segment (35a) there is a border (35c) that facilitates separation of the detachable segment (35b) and the fixed segment (35a),
the inner layer (22) comprises means (34, 36) other than said border (35c) to facilitate separation and subsequent withdrawal of the detachable segment (35b) from the cover (20).

8. Container (50) with an external surface, means (55) on the external surface to allow access in the interior of the container (50), the container (50) further including a cover (20) according to claim 1, whereby the inner layer (22) adheres to the external surface of the container (50) and whereby the detachable segment (35b) adheres to the external surface of the container (50) with reclosable adhesive.

9. Container (50) according to claim 8, whereby the means (55) on the external surface to allow access in the interior of the container (50) is an opening (55) and the detachable segment (35b) adheres to the external surface of the container (50) around the opening (55).

10. Container (50) according to claim 9 with a lid (53) that covers the opening (55), and the detachable segment (35b) adheres to the external surface of the container (50) around the lid (53).

11. Container (50) according to claim 8, whereby the cover (20) has a base section (37) fixed along an edge of the cover (20), which base section (37) adheres to the container (50), and a cut (36) between the base section (37) and the detachable segment (35b).

12. Container (50) according to claim 8, including a cover (20) according to any one of claims 6 to 8, whereby the means (55) on the external surface to allow access in the interior of the container (50) is an opening (55) with a lid (53) that covers the opening (55), and the fixed segment (35a) adheres to the lid (53).

13. A roll including a liner and a plurality of adhesive covers (20) according to claim 1 arranged along the liner.

14. Method of production of a roll with a plurality of covers (20), whereby each cover includes an outer layer (24), an inner layer (22) with a detachable segment (35b) that has an inner face that adheres to the outer layer (24) and an outer face that is at least partially covered with reclosable adhesive and whereby each cover (20) further comprises means (34, 36) facilitating the separation and removal of the detachable segment (35b) from the inner layer (22), the method comprising the following steps:
providing a roll with a liner (40) and a self-adhesive layer with a first face that adheres with reclosable adhesive to the liner and a free face;
applying a release varnish on predefined areas of the free face, whereby the predetermined areas correspond to the detachable segments (35b) of the covers (20) under production;
engraving or perforating the self-adhesive material of the roll to form a border (35c) of the detachable segment (35b) of the covers (20) under production and producing the means (34, 36) other than said border (35c) facilitating the separation and removal of the detachable segments (35b) from the inner layer (22) of the covers (20) under production;
adhering a further self-adhesive layer to the free face of the self-adhesive layer of the roll, whereby the predetermined areas that correspond to the detachable segments (35b) of the covers (20) under production adheres to an area of the further self-adhesive layer that is coated with reclosable adhesive;
engraving the sandwich of the self-adhesive layer of the roll and the further self-adhesive layer, so as to produce a plurality of covers (20) and waste material.

15. Method of production according to claim 14, whereby the predefined areas on which the release varnish is applied, enclose at least partially areas of the outer face of the inner layer (22), on which no release varnish is applied, so as to be fixed to the further self-adhesive layer.

16. Method according to claim 14, comprising engraving the self-adhesive material of the roll to form a border between the detachable segment (35b) and a fixed segment (35a) of the inner layer (22) of the covers (20) under production and perforating the self-adhesive material of the roll to form a border between the detachable segment (35b) and a flap of the covers (20) under production, whereby the fixed segment (35a) and the flap (33) of each cover (20) are distinct elements with at least part of the detachable segment (35b) being in between.

17. Method according to claim 14, comprising the following steps:
separating the liner (40) and the self-adhesive layer;
canceling or removing the adhesive on areas of the first face of the self-adhesive layer, which correspond to flaps (33) of the covers (20) under production;
recombine the liner (40) and the self-adhesive layer.

18. A roll including a liner and a plurality of adhesive covers (20) according to claim 2 arranged along the liner.

19. A roll including a liner and a plurality of adhesive covers (20) according to claim 3 arranged along the liner.
